(19) United States
(12) Patent Application Publication
(10) Pub. No.: US 2011/0250500 A1
(43) Pub. Date: Oct. 13, 2011

(54) POSITIVE ACTIVE MATERIAL FOR A LEAD-ACID BATTERY

(76) Inventors: Marvin C. Ho, Yorba Linda, CA (US); Jesus F. Perez Lopez, Chino, CA (US)

(21) Appl. No.: 12/758,551

(22) Filed: Apr. 12, 2010

(51) Int. Cl. H01M 4/38

(52) U.S. Cl. 429/226

(57) ABSTRACT

Positive active material pastes for flooded deep discharge lead-acid batteries, methods of making the same, and lead-acid batteries including the same are provided. The positive active material paste includes a lead compound, a carbon additive, and a silicon additive. The positive active material paste contains carbon additive at a lead to carbon additive weight ratio of 90 to 1900 and a silicon additive at a lead to silicon additive weight ratio of 200 to 4100.

### FIELD OF THE INVENTION

The present invention relates to flooded or wet cell lead-acid electrochemical batteries, and to methods of making and using the same.

### BACKGROUND OF THE INVENTION

A typical flooded lead-acid battery includes positive and negative plates and an electrolyte. Positive and negative active materials are manufactured as pastes that are coated on the positive and negative electrode grids, respectively, forming positive and negative plates. The electrode grids, while primarily constructed of lead, are often alloyed with antimony, calcium, or tin to improve their mechanical characteristics. Antimony is generally a preferred alloying material for deep discharge batteries. The positive and negative active material pastes generally comprise lead oxide (PbO or lead (II) oxide). The electrolyte typically includes an aqueous acid solution, most commonly sulfuric acid (H₂SO₄). Once the battery is assembled, the battery undergoes a formation step in which a charge is applied to the battery in order to convert the lead oxide of the positive plates to lead dioxide (PbO₂ or lead (IV) oxide) and the lead oxide of the negative plates to lead.

After the formation step, a battery may be repeatedly discharged and charged in operation. During battery discharge, the positive and negative active materials react with the sulfuric acid of the electrolyte to form lead (II) sulfate (PbSO₄). By the reaction of the sulfuric acid with the positive and negative active materials, a portion of the sulfuric acid of the electrolyte is consumed. However, under normal conditions, sulfuric acid returns to the electrolyte upon battery charging. The reaction of the positive and negative active materials with the sulfuric acid of the electrolyte during discharge may be represented by the following formulae.

Reaction at the Negative Electrode:

Pb(s)+SO₄²⁻(aq)PbSO₄(s)+2e⁻

Reaction at the Positive Electrode:

PbO₂(s)+SO₄²(aq)+4H⁺+2e⁻PbSO₄(s)+2(H₂O)(l)

As shown by these formulae, during discharge, electrical energy is generated, making the flooded lead-acid battery a suitable power source for many applications. For example, flooded lead-acid batteries may be used as power sources for electric vehicles such as forklifts, golf cars, electric cars, and hybrid cars. Flooded lead-acid batteries are also used for emergency or standby power supplies, or to store power generated by photovoltaic systems.

During operation of a flooded lead-acid battery using an electrode grid alloyed with antimony, antimony may leach or migrate out of the electrode grid. Antimony leaching undesirably shortens battery life.

### SUMMARY OF THE INVENTION

An embodiment of the present invention is directed to a positive active material for a flooded deep discharge lead-acid battery. The positive active material contains a compound of lead, a carbon additive, and a silicon additive.

Suitable carbon additives include activated carbon and graphite. The carbon additive may be present at a lead to carbon additive weight ratio of 90 to 1900. Or, the carbon additive may be present at 0.05 to 1.0 wt % based on the weight of the lead oxide (PbO) in the positive active material paste on a dry basis prior to the formation step. In a preferred embodiment, the carbon additive may be present at a lead to carbon additive weight ratio of about 475 (corresponding to about 0.2 wt % based on the weight of the lead oxide on a dry basis).

One suitable silicon additive includes fumed silica. The silicon additive may be present at a lead to silicon additive weight ratio of 200 to 4100. Or, the silicon additive may be present at 0.05 to 1.0 wt % based on the weight of the lead oxide (PbO) in the positive active material paste on a dry basis prior to the formation step. In a preferred embodiment, the silicon additive may be present at a lead to silicon additive weight ratio of about 1020 (corresponding to about 0.2 wt % based on the weight of the lead oxide on a dry basis).

Another embodiment of the present invention is directed to a method for preparing a positive active material for a flooded deep discharge lead-acid battery. The positive active material is formed to contain both carbon and silicon additives.

In another embodiment of the present invention, a flooded deep cycling lead-acid battery includes positive active material having carbon and silicon additives.

### BRIEF DESCRIPTION OF THE DRAWINGS

The accompanying drawings, together with the specification, illustrate various aspects and embodiments of the invention:

FIG. 1 is a schematic sectional view of a flooded deep discharge lead-acid battery according to one embodiment of the present invention;

FIGS. 2 through 5 are graphs comparing the cycle life of flooded deep discharge lead-acid batteries according to embodiments of the present invention to a control battery in which no carbon or silicon additives are used and other batteries in which carbon or silicon additives are used individually.

### DETAILED DESCRIPTION OF THE INVENTION

According to one embodiment of the invention, a positive active material paste for a flooded deep discharge lead-acid battery includes lead oxide, a carbon additive, a silicon additive, and an aqueous acid solution.

Prior to battery formation, the positive and negative active material paste comprises lead oxide (PbO or lead (II) oxide). Therefore, prior to formation it is useful to describe additives in a wt % based on the total weight of the lead oxide on a dry basis. However, after the battery undergoes a formation step and during operation, the total weight of each of the positive and negative active materials changes as the lead of the active material may be present in various forms including elemental lead, a lead compound such as various lead oxides or lead sulfate, and combinations thereof depending on which paste is being analyzed, and the state of charge or discharge of the battery. However, the amount of lead in the paste is generally constant. Therefore, after the formation step has been performed, it is useful to discuss a weight ratio of the additives to lead in the positive paste. The weight of the lead is the weight of the lead, whether the lead is in an elemental, oxide, or other faun. As used herein, a “carbon to lead weight ratio” or a “silicon to lead weight ratio” refers to a weight ratio of carbon or silicon to lead without regard to the form of the lead. For example, if the positive paste contained carbon and lead dioxide, the weight ratio of carbon to lead in the positive paste refers only to the weight of carbon to lead, thus the weight of the oxygen in the lead dioxide would not be included.

In this application, the conversions of weight percent to weight ratio were made with the following assumptions: 100 g of PbO contains 94.69 g of Pb, the carbon additive is 99.4% pure carbon, and the silicon additive is 99.25% pure fumed silica. One of skill in the art could easily convert the weight ratios to other weight percents when using materials of different weights or when using materials having different purities.

Nonlimiting examples of suitable carbon additives include activated carbon, graphite, or combinations thereof. Suitable types of graphite include flake graphite, synthetic graphite, or expanded graphite. Suitable graphite could have a surface area of from 9-25 m²/g. One preferred type of graphite is flake graphite having a particle size (d₅₀) of about 9 μm and a BET surface area of about 9 m²/g. Suitable activated carbon could have a BET surface area of between 1500 to 2500 m²/g. One preferred type of activated carbon has a particle size (d₅₀) of about 33 μm and a BET surface area of about 1600 m²/g.

The carbon additive may be present at a lead to carbon additive weight ratio of 90 to 1900 (corresponding to 0.05 to 1.0 wt % based on the weight of the lead oxide). In some embodiments, the carbon additive may be present at a lead to carbon additive weight ratio of 190 to 1900 (corresponding to 0.05 to 0.5 wt % based on the weight of the lead oxide). For example, the carbon additive may be graphite and the graphite may be present at a lead to graphite weight ratio of 475 (corresponding to about 0.2 wt % based on the weight of the lead oxide).

A nonlimiting example of a suitable silicon additive includes fumed silica. The silicon additive may be present at a lead to silicon additive weight ratio of 200 to 4100 (corresponding to 0.05 to 1.0 wt % based on the weight of the lead oxide). In some embodiments, the silicon additive may be present at a lead to silicon additive weight ratio of 400 to 4100 (corresponding to 0.05 to 0.5 wt % based on the weight of the lead oxide). For example, the silicon additive may be fumed silica and the fumed silica may be present at a lead to fumed silica weight ratio of about 1020 (corresponding to 0.2 wt % based on the weight of the lead oxide).

The carbon and silicon additives may be provided at the same or different weight percents. Preferably, the carbon and silicon additives may be provided at about the same weight ratio. For example, the carbon additive may be graphite, the silicon additive may be fumed silica, and each of the graphite and the fumed silica may be present at about 0.2 wt % based on the weight of the lead oxide (corresponding to a lead to graphite weight ratio of about 475 and a lead to fumed silica weight ratio of about 1020).

The carbon additive generally acts as a pore former and increases the porosity of the positive active material. The silicon additive generally aids in improving the utilization of positive active material by retaining electrolyte in the pore structure. Individually, these two components improve lead-acid battery performance. However, it was surprisingly found that these two components, in combination, appear to have a synergistic effect. It was found that small amounts of carbon and silicon additives in the active material provide significant improvements in battery performance.

The positive active material paste may also include a sulfate additive. The sulfate additive may be any suitable metal or metal oxide sulfate compound, nonlimiting examples of which include SnSO₄, ZnSO₄, TiOSO₄, CaSO₄, K₂SO₄, Bi₂(SO₄)₂, and In₂(SO₄)₃. Enough sulfate additive may be provided to the paste to yield a lead to metal (or metal oxide) molar ratio of about 90:1 to about 1000:1. Preferably, the lead to metal (or metal oxide) molar ratio of the positive active material paste may be between about 450:1 and about 650:1. Enough sulfate additive may be provided to the paste to yield a lead to metal (or metal oxide) weight ratio of about 170:1 to about 1750:1. For example, tin sulfate may be provided so that the lead to tin weight ratio of the positive active material may be about 800:1 to 1100:1. Preferably, the lead to tin weight ratio of the positive active material paste is about 900:1 which corresponds to an initial amount of tin sulfate of about 0.2 wt % in the positive active material paste applied to the positive grid prior to battery formation. Sulfate additives for flooded lead-acid batteries were described in U.S. patent application Ser. No. 12/275,158 entitled Flooded Lead-Acid Battery and Method of Making the Same, filed Nov. 20, 2008, which is incorporated herein by reference

A method for preparing a positive active material paste includes mixing lead oxide, a binder such as polyester fiber, a carbon additive, and a silicon additive to form a dry mixture. Water may then be added to the dry mixture and the mixture may be wet-mixed for a period of time. After wet-mixing, acid is added and mixing continues.

The carbon and silicon additives may be those as described above. The carbon and silicon additives may be included in weight percentages as described above. The sulfate additive may also be included as described above.

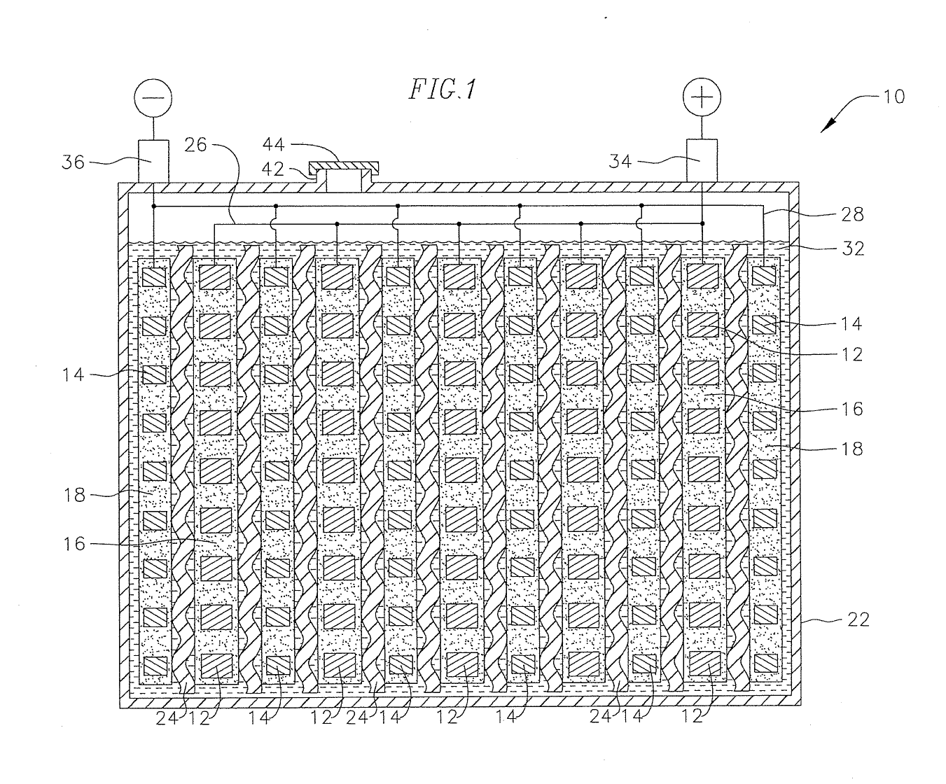

In one embodiment, as shown schematically in FIG. 1, a single cell flooded deep discharge lead-acid battery 10 includes the positive active material paste as set forth above. The battery includes a plurality of positive electrode grids 12, and a plurality of negative electrode grids 14. Each positive electrode grid is coated with a positive active material paste 16 to form a positive plate. Each negative electrode grid 14 is coated with a negative active material paste 18 to form a negative plate. The coated positive and negative electrode grids are arranged in an alternating stack within a battery case 22 using a plurality of separators 24 to separate each electrode grid from adjacent electrode grids and prevent short circuits. A positive current collector 26 connects the positive electrode grids and a negative current collector 28 connects the negative electrode grids. An electrolyte solution 32 fills the battery case, and positive and negative battery terminal posts 34, 36 extend from the battery case to provide external electrical contact points used for charging and discharging the battery. The battery case includes a vent 42 to allow excess gas produced during the charge cycle to be vented to atmosphere. A vent cap 44 prevents electrolyte from spilling from the battery case. While a single cell battery is illustrated, it should be clear to one of ordinary skill in the art that the invention can be applied to multiple cell batteries as well.

According to one embodiment, the positive electrode grids are made from a lead-antimony alloy. The electrode grids may be alloyed with about 2 wt % to about 11 wt % antimony. Preferably, the electrode grids are alloyed with between about 2 wt % and about 6 wt % antimony.

The negative electrode grids are similarly made from an alloy of lead and antimony, but generally include less antimony than the alloy used for the positive electrode grids. The negative electrode grids also tend to be somewhat thinner than the positive electrode grids. Such negative electrode grids are well known in the art. The negative electrode grids are coated with a negative active material that includes lead oxide and an expander as is well known in the art. Upon battery formation, the lead oxide of the negative active material is converted to lead.

Suitable electrolytes include aqueous acid solutions. The electrolyte may comprise a concentrated aqueous solution of sulfuric acid having a specific gravity of about 1.1 to about 1.3 prior to battery formation. The separators are made for any one of known materials. Suitable separators are made from wood, rubber, glass fiber mat, cellulose, polyvinyl chloride, or polyethylene.

The present invention will now be described with reference to the following examples. These examples are provided for illustrative purposes only, and are not intended to limit the scope of the present invention.

### Example 1

### Positive Active Material Paste and Positive Plate Formation

A positive active material paste was made by first mixing 10 lbs of lead oxide powder and 3.78 g of polyester fiber in a mixer. To that mixture, 9.08 g of fumed silica, 9.08 g of graphite, and 9.08 g of tin sulfate were added while mixing continued. Then, specified amounts of water and acid were added and mixing continued until a positive active material paste was formed. The positive paste included lead oxide, polyester fiber, fumed silica, graphite, tin sulfate, water, and aqueous sulfuric acid. The paste density was about 4.47 g/cm³, which is considered a high density paste and suitable for cycling applications. The resulting paste was gray in color and had a fumed silica concentration of about 0.2 wt % based on the weight of lead oxide on a dry basis, a graphite concentration of about 0.2 wt % based on the weight of lead oxide on a dry basis, and a tin sulfate concentration of about 0.2 wt % based on the weight of lead oxide on a dry basis.

The positive active material paste was applied to identical positive electrode grids using a Mac Engineering & Equipment Co. commercial pasting machine to form pasted positive plates. The positive electrode grids were cast using a Wirtz Manufacturing Co. grid casting machine using a lead-antimony alloy with 4.5% antimony. Each positive electrode grid was pasted with about 250 g (on a dry basis) of positive active material paste. The resulting positive plates were then dried in a flash drying oven according to well known methods. The dried positive plates were then cured by a two-step process in a curing chamber, first at 100% humidity for sixteen hours, and the plates were then dried under high temperature without humidity until the moisture content inside the plate was below 4%.

### Example 2

A positive active material paste and positive plates identical to those described at Example 1 were made using the method described at Example 1 with the exception that 2.27 g of fumed silica and 2.27 g of graphite were used. The resulting paste had a paste density of 4.58 g/cm³, a fumed silica concentration of about 0.05 wt % based on the weight of lead oxide on a dry basis, and a graphite concentration of about 0.05 wt % based on the weight of lead oxide on a dry basis.

### Example 3

A positive active material paste and positive plates identical to those described at Example 1 were made using the method described at Example 1 with the exception that 4.54 g of fumed silica and 4.54 g of graphite were used. The resulting paste had a paste density of 4.57 g/cm³, a fumed silica concentration of about 0.1 wt % based on the weight of lead oxide on a dry basis, and a graphite concentration of about 0.1 wt % based on the weight of lead oxide on a dry basis.

### Example 4

A positive active material paste and positive plates identical to those described at Example 1 were made using the method described at Example 1 with the exception that 22.7 g of fumed silica and 22.7 g of graphite were used. The resulting paste had a paste density of 4.30 g/cm³, a fumed silica concentration of about 0.5 wt % based on the weight of lead oxide on a dry basis, and a graphite concentration of about 0.5 wt % based on the weight of lead oxide on a dry basis.

### Example 5

A positive active material paste and positive plates identical to those described at Example 1 were made using the method described at Example 1 with the exception that 4.54 g of fumed silica and 4.54 g of activated carbon was used instead of graphite. The activated carbon used had a BET surface area of 1620 m²/g and a particle size (d₅₀) of 33 p.m. The resulting paste had a paste density of about 4.31 g/cm³, a fumed silica content of 0.1 wt % based on the weight of lead oxide on a dry basis, and an activated carbon concentration of about 0.1 wt % based on the weight of lead oxide on a dry basis.

### Example 6

A positive active material paste and positive plates identical to those described at Example 1 were made using the method described at Example 1 with the exception that 9.08 g of activated carbon (the same type of activated carbon as in Example 5) was used instead of graphite. The resulting paste had a paste density of about 4.39 g/cm³ and an activated carbon concentration of about 0.2 wt % based on the weight of lead oxide on a dry basis.

### Comparative Example 1

### Conventional Positive Active Material Paste and Plate Formation

A positive active material paste and positive plates identical to those described at Example 1 were made using the method described at Example 1 with the exception that no graphite or fumed silica was included in the positive active material paste. The resulting paste had a paste density of 4.56 g/cm³.

### Comparative Example 2

A positive active material paste and positive plates identical to those described at Example 1 were made using the method described at Example 1 with the exception that no graphite was included in the positive active material paste. The resulting paste had a paste density of 4.49 g/cm³.

### Comparative Example 3

A positive active material paste and positive plates identical to those described at Example 1 were made using the method described at Example 1 with the exception that no fumed silica was included in the positive active material paste. The resulting paste had a paste density of 4.58 g/cm³.

### Comparative Example 4

A positive active material paste and positive plates identical to those described at Example 1 were made using the method described at Example 1 with the exception that no fumed silica was included in the positive active material paste and 9.08 g of activated carbon was used instead of graphite (the same type of activated carbon as in Example 5). The resulting paste had a paste density of about 4.55 g/cm³ and an activated carbon concentration of about 0.2 wt % based on the weight of lead oxide on a dry basis.

### Comparative Example 5

A positive active material paste and positive plates identical to those described at Example 1 were made using the method described at Example 3 with the exception that 22.7 g of tin sulfate was used. The resulting paste had a paste density of about 4.39 g/cm³ and a tin sulfate concentration of about 0.5 wt % based on the weight of lead oxide on a dry basis.

Each of the positive plates of the above Examples and Comparative Examples were then assembled into test cells which have a similar design to production batteries of the type manufactured and sold by Trojan Battery Corporation as Model T875 (4 cells, 8-volt, deep discharge lead-acid battery, a type commonly used in electric golf cars). In particular, individual cell groups were formed by stacking 6 positive plates and 7 conventional negative plates in an alternating arrangement with conventional separators between them. The negative plates comprised negative electrode grids made from an alloy of 2.75 wt % antimony in lead. Each negative electrode grid was pasted with negative paste comprising lead oxide, deep cycle expander, polyester fiber, water, and aqueous sulfuric acid. The negative paste density was about 4.3 g/cm³, which represents a typical negative paste in the lead-acid battery industry. The positive plates were then dried in a flash drying oven and cured using the same procedures as were used for the negative plates. The separators used were rubber separators made by Daramic LLC. The deep cycle expander was provided by Atomized Products Group, Inc.

The tabs of the negative plates of each cell group were welded together using known procedures as were the tabs of the positive plates of each cell group. The cell was then sealed and the terminals were welded into place. The assembled cells were then filled with aqueous sulfuric acid and covers were placed over the vents. For each of the Examples and Comparative Examples, the assembled cells were connected in series, and within thirty minutes of filling the cells with acid, the formation step was initiated. According to the formation step, a charge was applied to the series of cells using a constant current formation procedure to form the plates. The formation was terminated when the total charge energy reached about 190 to about 220% of the theoretical charge energy based on the quantity of positive active material and charging efficiency. The final specific gravity of the aqueous sulfuric acid inside the cells was about 1.275.

For the tests, the cells were repeatedly discharged and charged using standard procedures as established by Battery Council International. In particular, the cells were discharged at a constant 56 amps down to a cut-off voltage of 1.75 V per cell. For each circuit, the time taken for each discharge cycle was determined in minutes. Once the cells of a circuit were discharged, the circuit was rested for 30 minutes before recharging. After the rest step, the cells were recharged using a three-step I-E-I charge profile up to 110% of the capacity discharged on the immediately preceding discharge cycle. In this 3-step charge profile, the first step employs a constant start current in which charge current to the cells is maintained at a constant value (in this case 14 A) during the initial charge stage until the voltage per cell (“VPC”) reaches a specified level (in this case 2.35VPC). In the second step, the cell voltage is maintained at a steady voltage while being charged with decreasing current. In the third step, a lower constant current is delivered to the cells (in this case 3.5 A). Such a charge profile is abbreviated in this specification as “IEI 56 A DIS 14 A-2.35VPC-3.5 A-110%.” Once recharged, the cell was rested for two hours before being discharged.

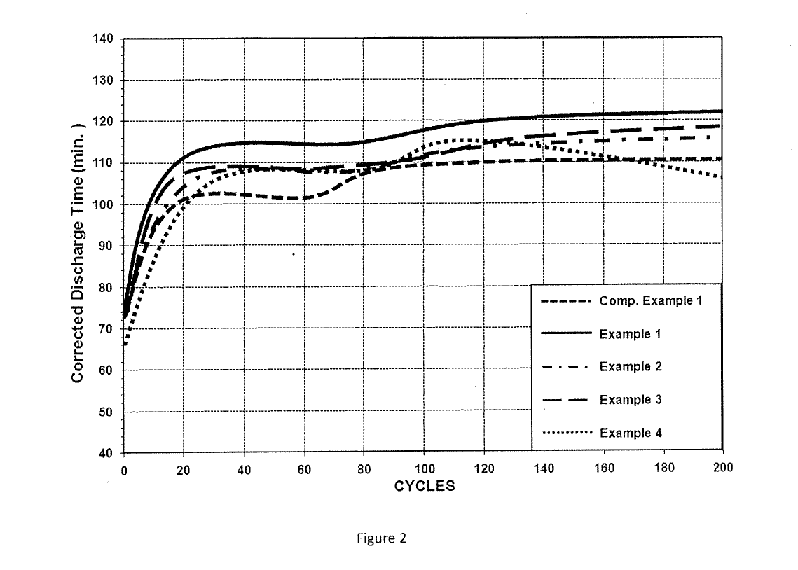

Results of the tests are shown in FIGS. 2-5, which graph elapsed discharge time per cycle against the number of cycles, where the discharge time per cycle is corrected for temperature using standardization procedures set forth by the Battery Council International.

As shown in FIG. 2, cells with graphite and fumed silica additives show better performance than the control cell in that a higher discharge time is indicative of higher capacity. Specifically, the cells shown in FIG. 2 demonstrate that batteries of the present invention exhibit consistently higher capacity. While most of the Examples showed improved performance over the control cell, Example 1, containing 0.2 wt % graphite and 0.2 wt % fumed silica, surprisingly exhibited a relatively high improvement when compared to the other examples.

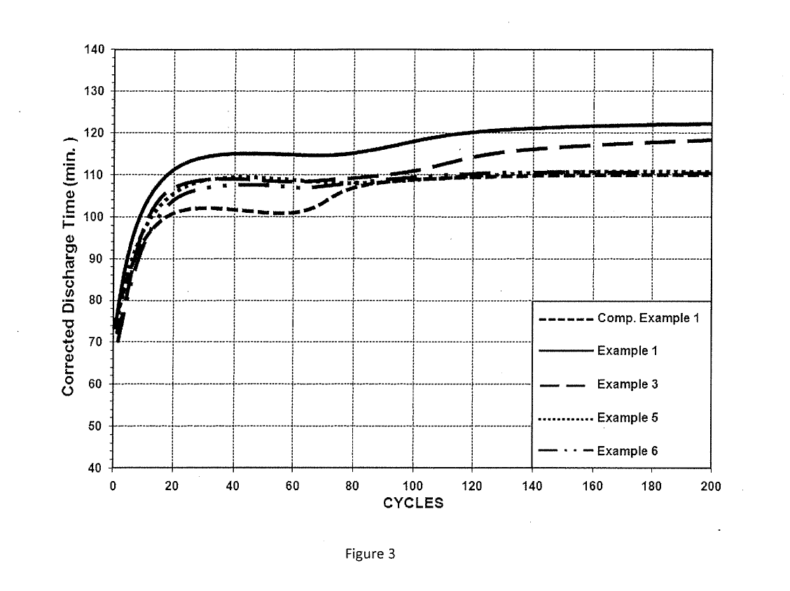

As shown in FIG. 3, cells with activated carbon and fumed silica additives have a higher capacity than the control cell. Additionally, the activated carbon/fumed silica additive cells had a capacity equal to or slightly below the capacity of the graphite/fumed silica additive cells with similar loadings.

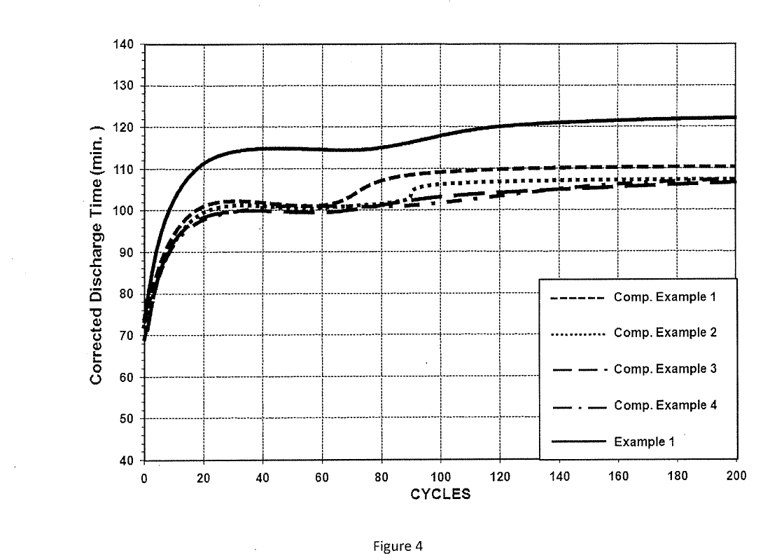

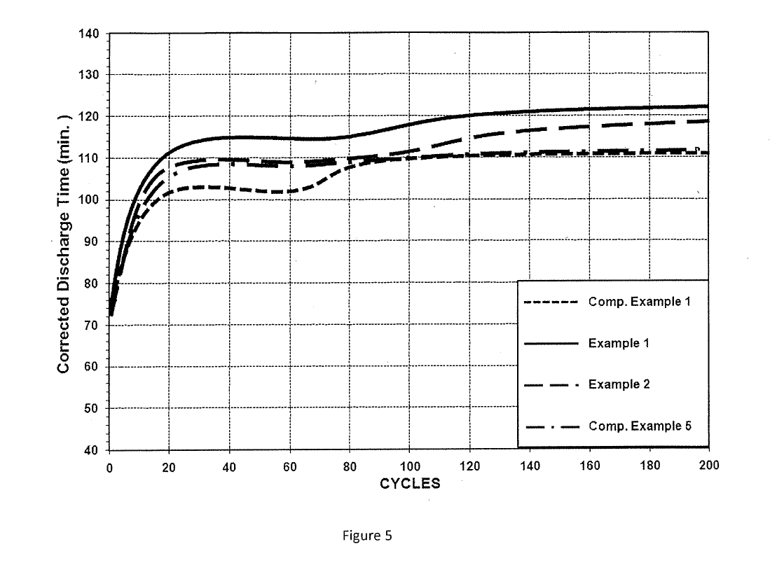

FIG. 4 demonstrates the effects of each of the additives individually. While some of the additives may individually have beneficial effects on battery capacity, FIG. 4 illustrates that the combination of carbon and silicon additives show synergistic improvement on cell capacity. FIG. 5 demonstrates that an increased amount of metal sulfate does not appear to improve cell capacity when carbon and silicon additives are present in the positive active material.

While the present invention has been illustrated and described with reference to certain exemplary embodiments, those of ordinary skill in the art would appreciate that various modifications and changes can be made to the described embodiments without departing from the spirit and scope of the present invention, as defined in the following claims.

What is claimed is:

1. A lead-acid rechargeable battery comprising:
at least one negative plate;
at least one positive plate comprising:
a positive electrode grid made of a lead-antimony alloy; and
a positive paste comprising a lead compound, a carbon additive, and a silicon additive; and
an electrolyte.

2. The battery of claim 1, wherein the carbon additive is graphite.

3. The battery of claim 1, wherein the positive paste has a lead to carbon additive weight ratio of 90 to 1900.

4. The battery of claim 3, wherein the lead to carbon additive weight ratio is about 475.

5. The battery of claim 1, wherein the silicon additive is fumed silica.

6. The battery of claim 1, wherein the positive paste has a lead to silicon additive weight ratio of 200 to 4100.

7. The battery of claim 6, wherein the lead to silicon additive weight ratio is about 1020.

8. The battery of claim 1, wherein the positive paste further comprises a metal or a metal oxide, wherein the metal or metal oxide is a metal or metal oxide other than lead or lead oxide.

9. The battery of claim 8, wherein the metal or metal oxide is tin.

10. The battery of claim 1, wherein the positive paste has a lead to carbon additive weight ratio of 90 to 1900 and a lead to silicon additive weight ratio of 200 to 4100.

11. The battery of claim 10, wherein the carbon additive is graphite and the silicon additive is fumed silica.

12. A lead-acid rechargeable battery comprising:
at least one negative plate;
at least one positive plate comprising:
a positive electrode grid made of a lead-antimony alloy; and
a positive paste comprising a lead compound, graphite, and fumed silica; and
an electrolyte.

13. The lead-acid battery of claim 12, wherein the positive paste has a lead to graphite weight ratio of 90 to 1900 and a lead to fumed silica weight ratio of 90 to 1900.

14. The lead-acid battery of claim 13, wherein the lead to graphite ratio is about 475 and the lead to fumed silica weight ratio is about 1020.

15. A lead-acid rechargeable battery comprising, prior to formation:
at least one negative plate;
at least one positive plate comprising:
a positive electrode grid made of a lead-antimony alloy; and
a positive paste comprising lead oxide, a carbon additive, and a silicon additive; and
an electrolyte.

16. The battery of claim 15, wherein the carbon additive is present at from 0.05 to 1.0 wt % based on the weight of the lead oxide on a dry basis.

17. The battery of claim 16, wherein the carbon additive is present at about 0.2 wt % based on the weight of the lead oxide on a dry basis.

18. The battery of claim 15, wherein the silicon additive is present at from 0.05 to 1.0 wt % based on the weight of the lead oxide on a dry basis.

19. The battery of claim 18, wherein the silicon additive is present at about 0.2 wt % based on the weight of the lead oxide on a dry basis.

20. The battery of claim 15, wherein the carbon additive is graphite and the graphite is present at 0.2 wt % based on the weight of the lead oxide on a dry basis, and the silicon additive is fumed silica and the fumed silica is present at 0.2 wt % based on the weight of the lead oxide on a dry basis.
